(19) United States
(12) Patent Application Publication
(10) Pub. No.: US 2005/0210269 A1
(43) Pub. Date: Sep. 22, 2005

(54) Method and a system for biometric identification or verification

(75) Inventor: Martin Tiberg, Vasteras (SE)

Correspondence Address: BEEM PATENT LAW FIRM, 53 W. JACKSON BLVD., SUITE 1352, CHICAGO, IL, 60604-3787, US

(73) Assignee: Prosection AB

(21) Appl. No.: 11/026,731

(22) Filed: Dec. 30, 2004

(30) Foreign Application Priority Data
Jul. 8, 2003 (WO) PCT/SE03/01181
Jul. 9, 2002 (SE) 0202147-5

(51) Int. Cl. H04K 1/00; H04L 9/00

(52) U.S. Cl. 713/186

(57) ABSTRACT

A method for biometric identification or verification of an individual includes reading reference biometric information, representing a characteristic inherent to the individual, encrypting the biometric information by means of an encryption key, storing the encrypted reference biometric information as a reference in a database, reading current biometric information from an individual, encrypting the current biometric information by means of an encryption key, comparing the encrypted current biometric information with the encrypted reference biometric information, and deciding, based on said comparison, whether the current biometric information originate from the same individual as the reference biometric information.

### BACKGROUND OF THE INVENTION

1. Field of the Invention

The present invention relates to a method for biometric identification or verification.

2. Description of the Related Art

It is known in the art to use biometric information for identification and verification of an individual. Known methods for biometric identification and verification of an individual comprise reading biometric information from individuals, transferring the biometric information to a database and store the information as references. When a person is to be identified, or the identity of the person is to be verified, biometric information is obtained from the person and compared with the stored reference information. For security reasons the reference biometric information is often encrypted before being transferred to and stored in the database. In some applications, the information is decrypted before being stored in the database and in other applications, the encrypted information is stored and decryption takes place after retrieval from the database. In both cases the comparison is carried out on decrypted biometric information.

An example of such a biometric system is disclosed in the US patent document U.S. Pat. No. 6,317,834 B1. Biometric templates are stored in a biometric database. Before the biometric templates are stored, they are encrypted by means of an encryption algorithm using a cryptographic key derived from a password. When an individual whishes to access a secured resource, he must provide a biometric sample and a correct password to allow the system to decrypt the stored templates before comparing the biometric sample with the biometric templates.

A disadvantage with systems for biometric identification or verification is that once the biometric information has been converted to electronic form it is possible to steal it. Since the biometric information is unique, it is not possible to change it and thus the damage is irreparable. This problem becomes especially severe when you use the same biometric information, for example your fingerprint, in several different security systems. You have only one fingerprint and if it is stolen the security of all biometric system using this fingerprint is compromised. The thief can now and everlastingly penetrate all the security systems, which are based on your fingerprint. It is known to protect the biometric information from being stolen by an outsider by encrypting the information when it is transferred over a network before it is encrypted and compared with the reference information. However, there must always be some trusted insiders to administrate the biometric security system along with the database, where the biometric information is stored, and it is still possible for the trusted insider to get hold of the decrypted information.

### SUMMARY OF THE INVENTION

It is an object of the present invention to provide a method for biometric identification or verification of an individual, which provides a higher degree of flexibility, integrity and privacy for the individual than existing methods.

A further object of the present invention is to provide a computer program product directly loadable into the internal memory of a computer, comprising software code portions for performing the steps of any of the methods according to the invention, when said product is run on a computer.

A further object of the present invention is to provide a computer readable medium having a program recorded thereon, where the program is to make a computer perform the steps of the method according to the invention when said program is run on the computer.

A further object of the present invention is to provide a system for biometric identification or verification of an individual, which system provides a higher degree of security, privacy and flexibility for the individual than existing systems.

The present invention relates to a method and a system for biometric identification or verification, comprising: reading reference biometric information, representing a characteristic inherent to the individual, encrypting the biometric information by means of an encryption key, storing the encrypted reference biometric information, reading current biometric information from an individual, and encrypting the current biometric information by means of an encryption key, and means for deciding whether the encrypted current biometric information and the encrypted reference biometric information are identical.

The present invention also relates to a system for biometric identification or verification of an individual, comprising a biometric information reader for example a scanner, that generates biometric information representing a characteristic inherent to the individual, an encrypting unit, encrypting the biometric information by means of an encryption key, a memory adapted for storing the encrypted biometric information, and means for deciding whether the encrypted current biometric information and the encrypted reference biometric information are identical.

### BRIEF DESCRIPTION OF THE DRAWINGS

The invention will now be explained more closely by the description of different embodiments thereof and with reference to the appended figures.

FIG. 1 shows a block diagram of a verification system for biometric identification or verification of an individual according to an embodiment of the present invention.

FIG. 2 shows flow chart of a method for biometric identification or verification of an individual according to an embodiment of the present invention.

### DETAILED DESCRIPTION OF THE INVENTION

In this application the term biometric information relates to physiological characteristics and behavior such as fingerprints, voiceprints, hand geometry, typing characteristics, facial appearances or signatures representing a characteristic inherent to an individual.

The invention is particularly useful in connection with authorization systems that verify the identity of a known person and authorize the person to perform an action. The action can be for example a financial transaction, such as check cashing, the use of a credit card or an automatic teller. The invention is also useful for identifying an unknown person by using biometric information. In a biometric identification system, biometric information from an individual is compared with stored information from many individuals in order to identify the individual.

This is achieved by a method, which includes comparing encrypted current biometric information with encrypted reference biometric information, and, based on said comparison, deciding whether the current biometric information originates from the same individual as the reference biometric information. Thanks to the fact that encrypted biometric information is compared, instead of decrypted biometric information, as in the prior art, the decryption step is omitted and no original biometric information will be stored in any database. Thus, the original biometric information is not accessible to any trusted insider. The security and the integrity and privacy of the individual are improved since only encrypted biometric information is handled. Not even trusted insiders will have the possibility to get hold of the original biometric information.

Since the reference and current encrypted information are compared, a condition for obtaining successful identification/verification of the individual is that the same encryption key is used for encrypting both the current biometric information and the reference biometric information. In an embodiment of the invention that condition has been utilized for further improvement of the security in the biometric system. In this embodiment, the individual biometric information is combined with a secret encryption key chosen by or assigned to the individual. The encryption key may, for example, be derived from a password, from information stored on a smart card, from the biometric information itself, or from a separate computer application. This embodiment comprises receiving a first encryption key, encrypting the reference biometric information by means of the first encryption key, receiving an second encryption key, and encrypting the current biometric information by means of the second received encryption key, and successful verification/identification of the individual is only possible if the first and the second encryption key are equal. If different encryption keys are used the comparison will fail. Accordingly, the security is further enhanced.

This embodiment provides the possibility to feed the encryption key to the system, which allows the encrypted information to easily be changed by simply changing the encryption key. Thus, if the encrypted biometric information is stolen, the user only needs to change to another secret encryption key and store new reference biometric information encrypted by means of the new encryption key in order to render the stolen information useless. It is also possible to use different encryption keys in different identification or authorization systems. This procedure makes it impossible to discover relationships between the same biometric information stored in different systems and accordingly the privacy of the individual is enhanced. A further advantage with using different encryption keys in different systems is that encrypted biometric information stolen from one system is useless in the other systems.

According to one embodiment of the invention, said comparison is performed by means of a statistical test. Preferably, said comparison comprises calculation of the correlation between the encrypted current biometric information and the encrypted reference biometric information, and the encryption is performed by means of an encryption method that retains the correlation between the encrypted information. Comparing biometric information is not a matter of simply comparing two numbers and determining whether they are equal or not. The exact encoding of each digital copy of the biometric information stemming from the same biometric characteristic of the same individual depends on the outside circumstances and when it is read it may fluctuate between different points of time. For instance, reading of fingerprints may depend on the temperature of the finger, the ambient humidity, and the orientation of the finger. Thus, the result of a reading of a fingerprint is not necessarily the same as the result of an earlier reading of the same finger.

By calculating the correlation between the reference and current biometric information, it is possible to determine whether the two originate from the same individual. Most of the conventional encryption methods change the biometric information such that any correlation between the reference and current information is lost after encryption. Therefore, it is impossible to use the encrypted information to determine whether the information originates from the same individual. According to the invention, an encryption method is chosen that retains the correlation between the encrypted information.

According to one embodiment of the invention, said encryption method comprises generating a random number using said encryption key and then generating encrypted biometric information based on said random number and the biometric information. Methods for encryption and decryption of information using random numbers are well known in the art. If bit-wise XOR-operation is used between the information and the random number it is called stream cipher. Such methods have the property of retaining the correlation between encrypted samples. Although it is known in the art to encrypt and decrypt information based on such methods, it is not known to utilize their property of retaining the correlation between encrypted information, in connection with encryption of biometric information.

The encrypted biometric information may be generated by any kind of transformation method based on the encryption key. It may act on each single bit, on blocks of data or on the whole data set. In an embodiment of the invention the encrypted biometric information is generated by convolving said random number and the biometric information. The convolving includes operations such as XOR, AND, NAND, OR, NOR. Before convolving them, the biometric information and the random number are converted to a binary stream of bits. It is important to have a uniform representation of data during processing. Preferably, the data is represented binary, but other representations are also possible, such as hexadecimal notation.

According to one embodiment of the invention, the method comprises determining whether the encrypted current biometric information and the encrypted reference biometric information are identical and if so generate an error signal. As mentioned before, biometric information from an individual normally fluctuates. It is extremely unlikely that two samples are identical taken at different points in time. If current biometric information is exactly identical to the stored biometric information, it is a potential fraud. Someone may have stolen the encrypted biometric information and is trying to get access to the system using the stolen information.

In one embodiment of the invention, the comparison is performed by a comparator, comparing currently generated and encrypted biometric information with previously generated and encrypted biometric information, which is stored as a reference, and means for deciding, based on said comparing, whether the current biometric information originates from the same individual as the reference biometric information

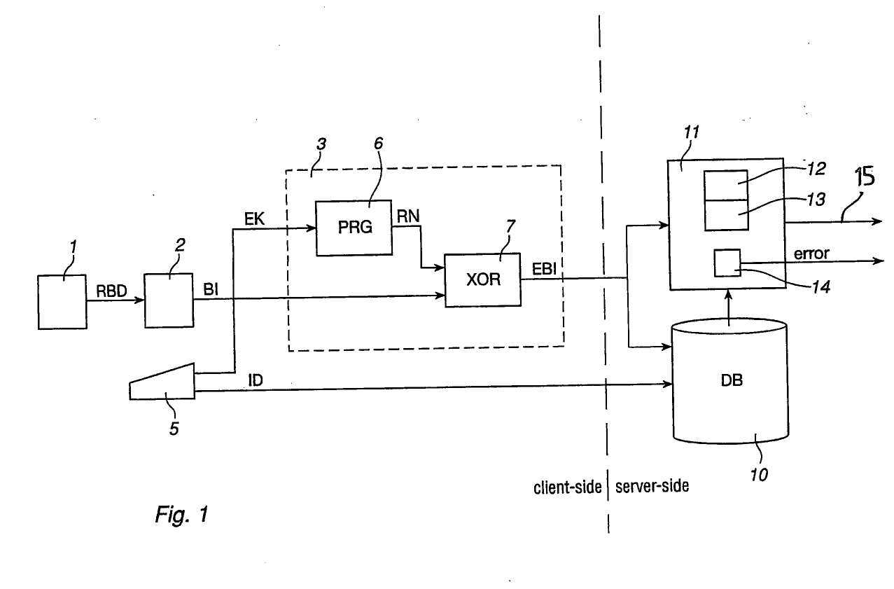

FIG. 1 shows a verification system for verifying the identity of a user. The verification system comprises two computationally separated parts: a client side, which acquires the inputs and initiates the verification process, and a server side, which performs matching of current user biometric information and previously stored reference biometric information. The data can be transferred between the client side and the server side in many different ways, for example wirelessly, by means of an optical link, a computer network or the Internet. Data may or may not be secured by encryption during the transfer.

The verification system comprises a biometric reader 1 which is used to read raw biometric data RBD from an individual. The reader is for example a scanner or an ultra sound detector. The present invention is independent of the type of biometrics used. Thus, the biometric reader can be any device that digitalizes any of the user's behavioral or physiological characteristics. The biometric reader is for example an image inputting device and then the raw biometric data is for example image data. The raw biometric data RBD is transferred to a feature extractor 2. The feature extractor 2 extracts from the raw biometric data features that are unique to the user. The output from the feature extractor 2 is biometric information BI comprising said unique features being useful for verification of the identity of the user. For example, if the biometric data represent a fingerprint, the biometric reader 1 is a fingerprint reader and the feature extractor 2 receives the data read by the fingerprint reader and extracts unique feature of the fingerprint appearing in that image. The biometric information BI generated by the feature extractor 2 is transferred to an encrypting unit 3 for encrypting of the biometric information. The encryption unit 3 comprises a pseudo random number generator 6 and an XOR function 7.

The client side also comprises an input device 5, for example a keyboard that is used for input of a user's ID and a password. In this case, the password is an encryption key EK, but in another embodiment, an encryption key may be derived from the password. The encryption key EK is transferred to the encrypting unit 3. Thus, input to the encryption unit 3 is the encryption key EK and the biometric information BI from the feature extractor 2. The encryption key and the biometric information must be converted into a stream of binary bits of 0 and 1, in case they are not already in that form. Computers almost exclusively communicate by bit streams; thus, the conversion consists simply of retrieving the input data in their raw forms. However, it is possible to implement a more sophisticated conversion algorithm, which has the biometric information and the encryption key as inputs in non-binary representation and encodes them into binary bit streams using any kind of encoding scheme. Preferably, the encoding scheme makes the bit streams as short as possible.

The encryption key EK is fed as a seed to the pseudo random number generator 6 that outputs a random number RN. The output from the random number generator is terminated when the random number has the same length as the biometric information BI received from the feature extractor 2. The encryption key uniquely determines the output of the pseudo-random number generator and the output cannot be reverse-engineered. A pseudo random number generator has the mathematically proven property: if the encryption key is k bits long and totally unknown, the random number generated cannot be distinguished from a truly random number of the same length by any statistical test which runs in poly-nominal time in k. Further definitions and properties of pseudo random number generators are disclosed in a book by Goldreich, O., “Foundations of Cryptography: Basic Tools”, ch. 3, Cambridge University Press, 2001. A pseudo-random number generator particularly suitable for this application is disclosed in a document written by Gennaro, R., “An Improved Pseudo-Random Generator based on the Discrete Logarithms Problem”, Crypto2000, pp. 469-481. For the implementation of the pseudo-random generator assumes knowledge of certain key algorithms, which are found in a book by Schneier, B., “Applied Cryptography”, 2^{nd} E d ., John Wiley & Sons, 1996.

The biometric information BI is convolved with to the random number RN by use of an XOR-operation. The output from the encrypting unit 3 is encrypted biometric information EBI. The encrypted biometric information EBI is transferred together with the corresponding user ID to the server side. The server side comprises a database 10 in which encrypted biometric information is stored together with the user ID. Encrypted biometric information samples from all individuals being enrolled in the system are stored as references together with their user ID in the database. The server side also comprises a verifying unit 11, which decides whether or not read biometric information belongs to the eligible person. The verifying unit 11 comprises a comparator 12, comparing current encrypted biometric information with the reference information stored in the data base 10 and means 13 for deciding based on said comparison, whether the current biometric information originates from the same individual as the reference biometric information.

Due to fluctuation in the biometric data received, the comparison has to be based on a statistical test. This statistical test checks whether the encrypted biometric information and the encrypted reference biometric information match to a satisfactorily high degree. For this purpose, the correlation between the current and the encrypted reference biometric information is calculated. If the correlation is within an allowed range, an approval signal 15 is generated and if the correlation is outside the allowed range, a disapproval signal is generated. The method used for measuring the correlation can be any of the methods known in the art. Which correlation method is used depends on the type of biometric data, how the algorithm inter-operates with the feature extractor and other factors.

The server side may further comprise a second comparator 14, comparing the current and the previously stored encrypted biometric information. This second comparator 14 compares the information and generates an error signal, if the biometric samples are identical. The purpose of this second comparator is to prevent reuse or theft of digital biometric information. The nature of biometrics is such that two samples of the same biometric type from the same individual closely resembles each other. However, it is extremely unlikely that two samples will be identical. If that is the case, it is more likely that someone has duplicated the electronic version of the encrypted biometric information and reuses it. As a protection against such copying, the system comprises a test of whether the encrypted biometric information samples are identical and it generates an error signal if they are identical.

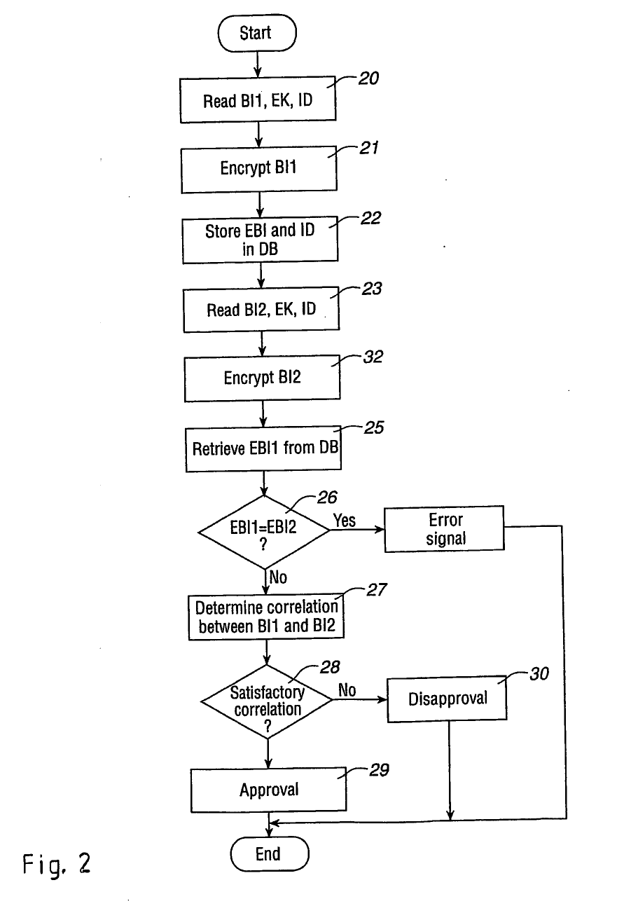

FIG. 2 is a flow-chart illustration of the method and the computer program product according to an embodiment of the present invention. It will be understood that each block of the flow-card can be implemented by computer program instructions run on one or several computers. In the present embodiment the program is run on two computers, a client computer and a server computer. In block 20, biometric information BI1 is read from the feature extractor 2, and the password EK and the user ID is read from the keyboard 5. In this embodiment the password is equal to the encryption key. If the password is not equal to the encryption key, an operation has to be performed to derive the encryption key from the password.

In block 21, the biometric information BI1 is encrypted. The encryption key EK is used as a seed to the pseudo-random generator 6 that generates a random number RN. The random number RN and the biometric information BI1 are convolved by an XOR operation. As a result, encrypted biometric information EBI1 is obtained. The encrypted biometric information EBI1 and the ID are transferred from the client side to the server side. The encrypted biometric information EBI1 and the ID are stored in the database 10 as a reference for future verification of that person, block 22. The database comprises encrypted reference biometric information from all persons being authorized in the system.

When a person is to be authorized by the system, his biometric data are read and he enters the password and the user ID. If necessary, the encryption key is derived from the password. For the authorization to be successful, the encryption key must be the same as the encryption key used for encryption of the reference biometric information. If the encryption key is not the same, the verification process will fail. The biometric information BI2, the encryption key EK, and the user ID are read by the system, block 23, and encrypted in the same way as the reference biometric information BI1, block 24. The encrypted biometric information EBI2 is transferred to the server side together with the user ID. The encrypted reference biometric information EBI1 corresponding to the ID is retrieved from the database 25.

In block 26, the received encrypted biometric information EBI2 is compared, bit-by-bit, with the stored encrypted reference biometric information EBI1. If they are identical, an error signal is generated. The encrypted biometric information EBI2 is also compared with the reference encrypted biometric information EBI1 by calculation of the correlation between them, block 27. Based on the degree of correlation between EBI1 and EBI2, it is decided whether the current biometric information EBI2 originates from the same individual as the reference biometric information EBI1, block 28. If the correlation is high, the system generates an approval signal, block 29, and if the correlation is low, a disapproval signal is generated, block 30.

The present invention is not limited to the embodiments disclosed but may be varied and modified within the scope of the following claims. For example the method is described in connection with verifying the identity of a user, but it could just as well be used for identifying a user. If a user is to be identified, no user ID is provided to the system. The encrypted biometric information is compared with stored encrypted reference biometric information originating from many individuals, and if any of the database records with reference information is found having a high correlation with the current biometric information the person is identified.

The step of determining whether the current encrypted biometric information and the previously stored encrypted biometric information match to a satisfactorily high degree for approval, comprises the use of a criterion, for example a range for the correlation. This matching criterion could either be fixed or adjustable, such that a third-party application or some other component connected to the system can specify the required criterion and range. The adjustable range or criterion may be specified for each user or application. In an embodiment of the invention, the encrypted reference biometric information in the database may be automatically adjusted in connection with approval. By blending the current and the reference encrypted biometric information using some blending criterion, new encrypted biometric information may be created, which can replace the encrypted reference biometric information. This new encrypted biometric information is likely to better corresponding to the real biometric of the person, since it is created using an additional biometric sample, which is acquired more recently than the old reference sample.

In another embodiment, it is possible to use several types of biometrics. A third-party application or some other component of or connected to, the system can specify the required criterion for approval. That criterion may be based on any one of the biometrics used in the system or a combination of several biometrics.

In the embodiment disclosed, the system comprises two separate parts each including at least one computer. However, those separate parts do not necessary need to be separated. Those parts may be put together and be integrated in a stand-alone application, which needs a biometric security mechanism.

The invention is not limited to identification/verification of human beings but could also be applicable on animals. The biometric characteristics may also comprise a physical object belonging to an individual, such as a watch or piece of jewellery.

1. A method for biometric identification or verification of an individual, comprising:
reading reference biometric information, representing a characteristic inherent to the individual,
encrypting the biometric information by means of an encryption key,
storing the encrypted reference biometric information as a reference,
reading current biometric information from an individual,
encrypting the current biometric information by means of an encryption key wherein the encryption is performed by means of an encryption method that retains the correlation between the encrypted information, calculating the correlation between the encrypted current biometric information and the encrypted reference biometric information,
comparing the encrypted current biometric information with the encrypted reference biometric information based on said calculated correlation, and
deciding, based on said comparison, whether the current biometric information originate from the same individual as the reference biometric information.

2. A method according to claim 1, wherein the same encryption key is used for encrypting the reference biometric information and the current biometric information.

3. A method according to claim 1, wherein the method further comprises: receiving a first encryption key, encrypting the reference biometric information by means of the first encryption key, receiving an second encryption key, and encrypting the current biometric information by means of the second received encryption key, and a condition for successful verification/identification of the individual is that the first and the second encryption key are equal.

4. A method according to claim 1, wherein said comparing is performed by means of a statistical test.

5. (canceled)

6. A method according to claim 1, wherein said encryption method comprises generating a random number using said encryption key and then generating encrypted biometric information based on said random number and the biometric information.

7. A method according to claim 6, wherein the encrypted biometric information is generated by convolving said random number and the biometric information.

8. A method according to claim 7, wherein the biometric information and said random number are converted into a binary stream of bits before convolving them.

9. A method according to claim 1, wherein the method comprises determining whether the encrypted current biometric information and the encrypted reference biometric information are identical and generate an error signal if they are identical.

10. A computer program product directly loadable into the internal memory of a computer, comprising software code portions for performing the following steps when said product is run on a computer:
reading reference biometric information, representing a characteristic inherent to the individual,
encrypting the biometric information by means of an encryption key,
storing the encrypted reference biometric information as a reference,
reading current biometric information from an individual,
encrypting the current biometric information by means of an encryption key, wherein the encryption is performed by means of an encryption method that retains the correlation between the encrypted information,
calculating the correlation between the encrypted current biometric information and the encrypted reference biometric information,
comparing the encrypted current biometric information with the encrypted reference biometric information based on said calculated correlation, and
deciding based on said comparison, whether the current biometric information originate from the same individual as the reference biometric information.

11. A computer readable medium having a program recorded thereon, where the program is to make a computer perform the following steps when said program is run on the computer:
reading reference biometric information, representing a characteristic inherent to the individual,
encrypting the biometric information by means of an encryption key,
storing the encrypted reference biometric information as a reference,
reading current biometric information from an individual,
encrypting the current biometric information by means of an encryption key, wherein the encryption is performed by means of an encryption method that retains the correlation between the encrypted information,
calculating the correlation between the encrypted current biometric information and the encrypted reference biometric information,
comparing the encrypted current biometric information with the encrypted reference biometric information based on said calculated correlation, and
deciding, based on said comparison, whether the current biometric information originate from the same individual as the reference biometric information.

12. A system for biometric identification or verification of an individual, comprising
a biometric information reader, for reading biometric information representing a characteristic inherent to the individual,
an encrypting unit for encrypting the read biometric information by means of an encryption key, wherein the encrypting unit is using an encryption method that retains the correlation between the encrypted information,
a memory adapted for storing the encrypted biometric information,
a comparator for comparing currently read and encrypted biometric information with previously read and encrypted reference biometric information, wherein the comparator comprises means for calculation of the correlation between the encrypted current biometric information and the encrypted reference biometric information, and
means for deciding based on said comparison, whether the current biometric information originates from the same individual as the reference biometric information.

13. (canceled)

14. A system according to claim 12, wherein said encryption unit comprises a pseudo-random number generator using the encryption key for generation of a random number and the encryption means is adapted to generate encrypted biometric information based on said random number and the biometric information.

15. A system according to claim 12, wherein the encrypting unit adapted to generate encrypted biometric information by convolving said random number and the biometric information.

16. A system according to claim 12, and further comprising a second comparator for comparing said currently read and encrypted biometric information with said previously read and encrypted reference biometric information, and an error signal generator, for generating an error signal if the encrypted current biometric information and the encrypted reference biometric information are identical.

17. A system according to claim 12, and further including an input means for feeding said encryption key to the system.
